(19) United States
(12) Patent Application Publication
(10) Pub. No.: US 2010/0084099 A1
(43) Pub. Date: Apr. 8, 2010

(54) POLYGONAL TILT DRUM FOR VENETIAN BLINDS

(76) Inventor: Tser Wen CHOU, Taipei City (TW)

Correspondence Address: SINORICA, LLC, 2275 Research Blvd., Suite 500, ROCKVILLE, MD, 20850, US

(21) Appl. No.: 12/367,618

(22) Filed: Feb. 9, 2009

(30) Foreign Application Priority Data
Oct. 3, 2008 (TW) 097217791

(51) Int. Cl. E06B 9/30; E06B 9/307

(52) U.S. Cl. 160/170; 160/177 R

(57) ABSTRACT

A ladder drum for adjusting and regulating the angular orientation and closure of horizontal slats of a venetian blind, of the type incorporating ladder cords or tape ladders, having a polygonal profiled structure comprising a series of planar sidewalls defining a substantially hollow interior. The number of sidewalls defining the polygonal structure is greater than four sidewalls, and less than or equal to twelve sidewalls, with each adjacent plane sidewall having an internal angular orientation in the range of 90° to 150°. To enhance the uniform closure of the slats of a horizontal blind, the polygonal ladder drum is more preferably in the form of an uneven hexagon that is either formed from injection molded plastics or a metal die stamping. The opposing top and bottom sidewalls are greater in measurement than the remaining mediate sidewalls, with at least two opposing mediate sidewalls having attachment means to insert and retain ladder cords in a counter balanced relation. The lateral peripheral edges of the profile body have either flared openings or notches to catch and re-spool misaligned ladder cords. Ladder tapes may also be secured to the profile structure through die cut serrated prongs or through the use of a detachable serrated clip.

### BACKGROUND OF THE INVENTION

1. Field of the Invention

The present invention relates to venetian blind components, and more specifically to adjustable tilt drums that regulate the angular orientation of horizontal slats in a window blind. In particular, the invention features a polygonal tilt drum that enhances the uniform closure of slats, and further provides for the re-spooling of misaligned ladder cords in a venetian blind assembly.

2. Discussion of the Prior Art

Venetian blinds have enjoyed widespread use as a decorative and functional solution for providing privacy and light control for windows. Typically, these coverings feature a sequence of horizontally oriented slats that are suspended beneath a headrail through the use of woven fabric ladder tapes and, more recently, braided ladder cords. At least two ladders are required to assemble a blind, where more may be required depending on the overall width of the window covering and the kind of slat material used within the construction. Each type of ladder includes a pair of vertically extending legs that are interconnected by a plurality of horizontal rungs spaced at regular intervals, which support and retain the slats in parallel fashion. The upper ends of each ladder are correspondingly attached to a tilt drum, which is carried on a tilt rod located within the headrail. The bi-directional rotation of the tilt rod causes the tilt drums to uniformly turn in response to the selective adjustment of the tilting mechanism. The reciprocating movement of each tilt drum will vertically raise one leg of each ladder cord or tape, while alternately lowering the corresponding leg of each ladder, thereby causing the attached rungs and slats to slant in relation to the vertical orientation of the parallel ladder legs. Accordingly, with this traditional assembly, the slats of a venetian blind may be opened, closed or adjusted to control privacy and the degree of light entering a room.

Usually, most prior art tilt mechanisms for venetian blinds utilize cylindrically shaped tilt drums, which have an attachment means for securing braided ladder cords, fabric ladder tapes, or are designed to accept the selection of either ladder style. Such parts may be fabricated from metal stampings or, alternatively, may be formed from injection molded plastic. One of the known disadvantages of using these barrel-shaped components relates to their unfavorable effect in attaining uniform closure among the slats of a horizontal blind. This is due to the fact that when the suspended slats are adjusted into a fully closed position, the tilt mechanism winds the ladder cords or tapes around each tilt drum, thereby increasing their overall diameter. In this particular instance, the enlarged outside dimension of the tilt drum inhibits the full range of vertical motion in the uppermost segments of each ladder leg, thus limiting the effective closure of the top slat of an assembled blind. For blinds using ladder cords, clips have been used to secure the uppermost slat to the top rung of each ladder, retaining the slat into position so that it may follow the complete perpendicular movement of the ladder legs—such clasps are typically made of translucent plastic and become brittle with long term exposure to sunlight.

Another attempt for improving the closure of venetian type blinds has been disclosed by Tyner, in U.S. Pat. No. 6,622,770, wherein the profile of the tilt drum mechanism is generally elliptical or oval in shape. According to the invention, the contour of the tape drum causes the legs of the ladder to move in unison throughout the vertical length of the blind, and particularly in the region located closest to the top slat. However, the major diameter of this elliptically shaped tilt drum orients the significant weight of the suspended slats away from the central supporting axis of the tilt rod. This increases the load on the axial passage molded into the more slender region of the plastic component. Furthermore, this unbalanced weight displacement inhibits the smooth angular rotation of the slats as they are adjusted by the tilting mechanism.

The more recent widespread use of lightweight ladder cords has also presented problems in the trouble free operation of venetian blinds. Specifically, the flexible properties inherent within braided cords can result in the misalignment of such ladders, which then may become entangled within the tilt mechanism of a venetian blind. Where the wider woven construction of ladder tapes promotes the proper alignment of ladder legs, in relation to the tilt drum, the sinewy fabrication of ladder cords requires the constant application of tension in order to maintain such alignment. When the slats of a venetian blind are completely raised and locked into place, the tension retaining the ladder cords into position dissipates, causing the formation of slack in the ladder legs. In this condition, the attached legs of the ladder cord may unspool from the tilt drum and become entangled with other components of the tilt mechanism. Without adjustment, the tangled cords will result in the unleveled suspension of slats when they are lowered for light control or privacy.

Accordingly, it is an object of the present invention to provide a resilient tilt drum for venetian type blinds that improves the closure of suspended slats within such window coverings.

It is a further object of the invention to provide a tilt drum having a profile in the form of a polygonal structure consisting of a plurality of faceted sidewalls encompassing a central supporting tilt rod aperture.

It is yet another object of the invention to provide a tilt drum having features that effectively counter balance the weight of suspended slats—to enhance the ease of operation—while additionally facilitating the efficient attachment of ladder cords.

Finally, an object of the invention is to provide a tilt drum wherein a pair of laterally converging access slots, used for the insertion and attachment of corresponding ladder legs, have notched openings to catch and re-spool misaligned ladder cords in a venetian blind.

These and other objects of the invention will be apparent to those skilled in the art from the following detailed description of the preferred embodiments of the instant invention.

### SUMMARY OF THE INVENTION

The disadvantages and limitations of the background art discussed above are overcome by the present invention. With this invention, an improved drum component for use within venetian blind tilting mechanisms is provided, wherein a polygonal structure—preferably in the form of an uneven hexagon—encompasses a central supporting tilt rod aperture. The hexagonal facets of the tilt drum enhance the full range of vertical motion for the corresponding legs of ladder cords or tapes, thereby facilitating a tighter closure among the suspended slats.

In accordance with the present invention, the polygonal tilt drum is preferably formed from injection molded plastic comprising a series of six outer sidewalls, with each adjoining wall oriented at 120° degrees to one another, defining a hollow hexagonal body. The top and bottom walls of the profile body are equal in measurement, where the four remaining sidewalls are of equal dimension but somewhat shorter than the top and bottom segments. The hollow profile is segmented by a set of two primary ribs that diverge at vertical angles from a central tilt rod support aperture—which extends lengthwise through the tilt drum—defining a sequence of four cavities. The smaller top and bottom cavities provide structural integrity to the tilt drum profile, where the two larger left and right mediate cavities are fashioned to receive corresponding tabbed ends of the braided ladder cord. Within the upper sidewall of each mediate cavity, a tapered access slot—terminating with an enlarged intersecting circular aperture—accommodates the insertion and retention of a single tabbed end of the ladder leg. The corresponding tapered access slots are in parallel relation to each other, and laterally converge from the upper front and rear mediate edges of the polygonal tilt drum. Within a preferred embodiment of the invention, and to effectively counter balance the weight of the suspended slats, the tabbed end segments of the ladder legs cross over the body of the tilt drum, and each are inserted within the opposite facing access slot of the component part. The access slots additionally have notched openings to catch and re-spool misaligned ladder cords upon the rotation of the venetian blind tilt mechanism.

Within an alternate embodiment of the invention, the polygonal tilt drum may also be fabricated from a die stamping, wherein a metal blank is cut and creased into a series of seven rectangular shaped facets, with two connected laterally extending hexagonal side sections, all of which fold inward to form the preferred hollow hexagonal profile. Each adjoining rectangular facet or sidewall is oriented at 120° to one another, where the two extending hexagonal side sections are bent at right angles. The top and bottom walls of the profile body are equal in measurement, and the bottom surface of the tilt drum defines an opening into the hollow tilt drum cavity, which is framed by two small rectangular facets and two opposing edge segments of the folded hexagonal sections. The four remaining mediate sidewalls are of equal dimension but somewhat shorter than the top and bottom surfaces. The sidewalls of the tilt drum are enfolded around the peripheral edges of the hexagonal side sections. A series of relief notches, along with V-shaped crimped notches, also serve to catch and re-spool misaligned ladder cords upon the rotation of the venetian blind tilt mechanism—when such ladders are selected for assembly. The hexagonal side sections additionally have a die cut aperture to accommodate the insertion of a tilt rod, and each section has two die stamped grooves to provide structural strength to the component. To facilitate the attachment of the braided ladder cord, the two upper mediate side walls of the polygonal tilt drum are each die cut with two intersecting ovular holes, the first opening greater in proportion than the second, to accommodate the attachment of the cord support legs. An enlarged tab is firmly attached to each end of each leg of the ladder cord, and to effectively counter balance the weight of the suspended slats, the tabbed end segments of the ladder legs cross over the body of the tilt drum, and each tab is then correspondingly inserted into the larger openings and subsequently moved and secured into position behind each smaller ovular opening. The polygonal tilt drum may optionally have die stamped serrated prongs to retain the loops of woven ladder tape, with the inward facing edge of each member having saw-toothed projections to grip and secure each ladder leg into position. Alternatively, the tilt drum may also accommodate the use of ladder tapes through the use of a cotter key attachment—having a set of retaining prongs—to fasten the loops formed at the top ends of each corresponding ladder leg; the assembly of which is then inserted into an access slot that is die cut into the top wall of the profile body.

In yet another alternate embodiment of the invention, the polygonal tilt drum may be adapted to accommodate the insertion of a serrated U-shaped clip to retain woven ladder tapes. So that the ladder clip may be fitted into position, the top sidewall of the injection molded tilt drum is formed with a recess along the peripheral edge of the component, in combination with two holes located on the top plane of the profile which are adjacent to the indented recess. The U-shaped clip is preferably a metal die stamping, which is generally of the same width as the molded recess, and is folded over to clasp the top sidewall of the tilt drum. The clip may be formed with a pattern of circular indentations, wherein at least two impressions correspondingly friction fit with the holes located within the top sidewall or, alternatively, may have die cut holes to receive fasteners. To retain the loops of the woven ladder tape into position, the inward facing edge of each projection has serrations, with each tooth having a ramp facing the open-end portion of the clip, and each having a right-angle stop surface facing the U-shaped terminus of the part. The looped ends of each ladder leg are slid over each corresponding projection of the U-shaped clip, which is then inserted into the tilt drum recess.

Further objects and advantages of the present invention will be apparent from the following description of the preferred embodiments when considered in conjunction with the accompanying drawings.

### BRIEF DESCRIPTION OF THE DRAWINGS

FIG. 1 is a perspective view of a polygonal tilt drum for a venetian blind in accordance with the present invention;

FIG. 2 is a top view of the polygonal tilt drum illustrating the location of the tapered access slots for the insertion of tabbed ladder cord legs;

FIGS. 3 is a perspective view of a polygonal tilt drum, illustrating the counter balanced attachment of the ladder legs, with the drum carried by the tilt rod;

FIGS. 4a and 4c are profile views of the polygonal tilt drum, illustrating the functional attachment of the ladder tapes in conjunction with the tapered access slots, in progressive stages of operation;

FIGS. 5a-5c are profile and perspective views illustrating how the removal of tension can lead to the misalignment of ladder cord, and its subsequent entanglement within a venetian blind tilt mechanism;

FIGS. 6a-6h are profile views of the polygonal tilt drum, illustrating the progressive re-spooling of misaligned ladder cord, in accordance with the present invention;

FIG. 7 is a perspective view of the polygonal tilt drum, within a tilt mechanism assembly, illustrating the proper alignment of the ladder cord after the re-spooling process;

FIGS. 8a-8h are plan and perspective views of the polygonal tilt drum fabricated from a metal stamping; and

FIGS. 9a and 9b are perspective views of an adapted polygonal tilt drum and serrated U-shaped clip for use with woven ladder tapes.

### DETAILED DESCRIPTION OF THE PREFERRED EMBODIMENT

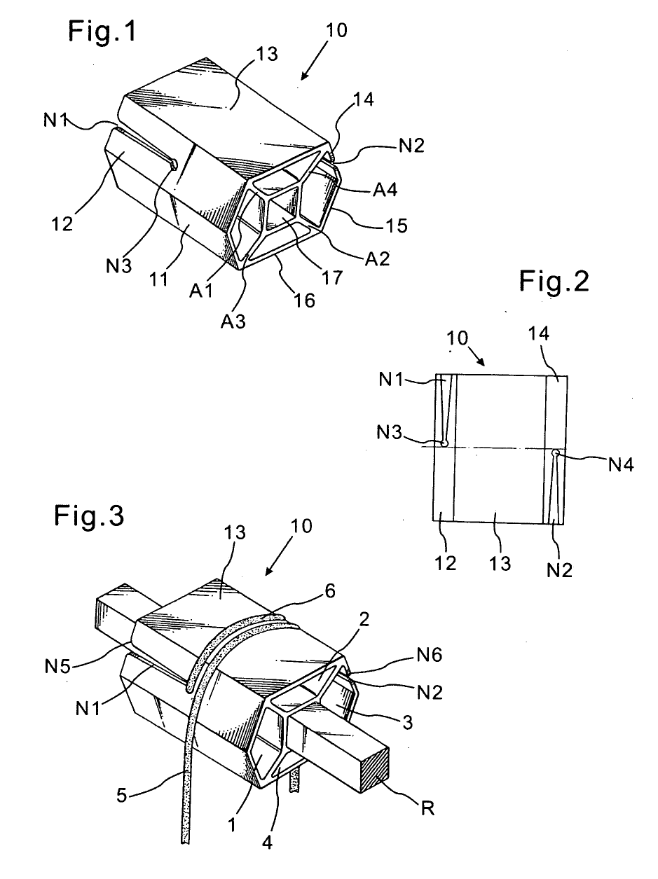

With reference to FIGS. 1, 2, and 3, polygonal tilt drum 10 for use within venetian blind tilting mechanisms is provided, wherein a series of six outer sidewalls 11, 12, 13, 14, 15, and 16, with each adjoining wall oriented at 120° degrees to one another, define a hollow hexagonal body. The top wall 13 and bottom wall 16 of the profile body are equal in measurement, where the four remaining sidewalls 11, 12, 14, and 15 are of equal dimension but somewhat shorter than the top and bottom segments. The hollow profile is segmented by a set of two primary ribs A1-A2 and A3-A4, which are oriented at vertical angles and diverge from the central tilt rod supporting aperture 17—which extends lengthwise through the tilt drum 10—defining a sequence of four cavities 1, 2, 3, and 4. The small top and bottom cavities 2 and 4 provide structural integrity to the tilt drum profile, where the two larger left and right mediate cavities 1 and 3 are fashioned to receive corresponding tabbed ends of the braided ladder cord. Within the upper sidewalls 12 and 14 of each mediate cavity 1 and 3, a tapered access slots N1 and N2—each terminating with enlarged intersecting circular aperture N3 and N4—accommodates the insertion and retention of a single tabbed end of ladder legs 5 and 6. The corresponding access slots N1 and N2 are in parallel relation to each other, and laterally converge from the front edge of sidewall 14 and the rear edge of sidewall 12, respectively. Within a preferred embodiment of the invention 10, and to effectively counter balance the weight of suspended slats, the tapped end segments (not shown) of the ladder legs 5 and 6 cross over the body of the tilt drum, and each are inserted within the opposite facing access slots N1 and N2 of the component part. The access slots additionally have enlarged notched openings N5 and N6, to catch and re-spool misaligned ladder legs 5 and 6 upon the rotation of the venetian blind tilt rod R.

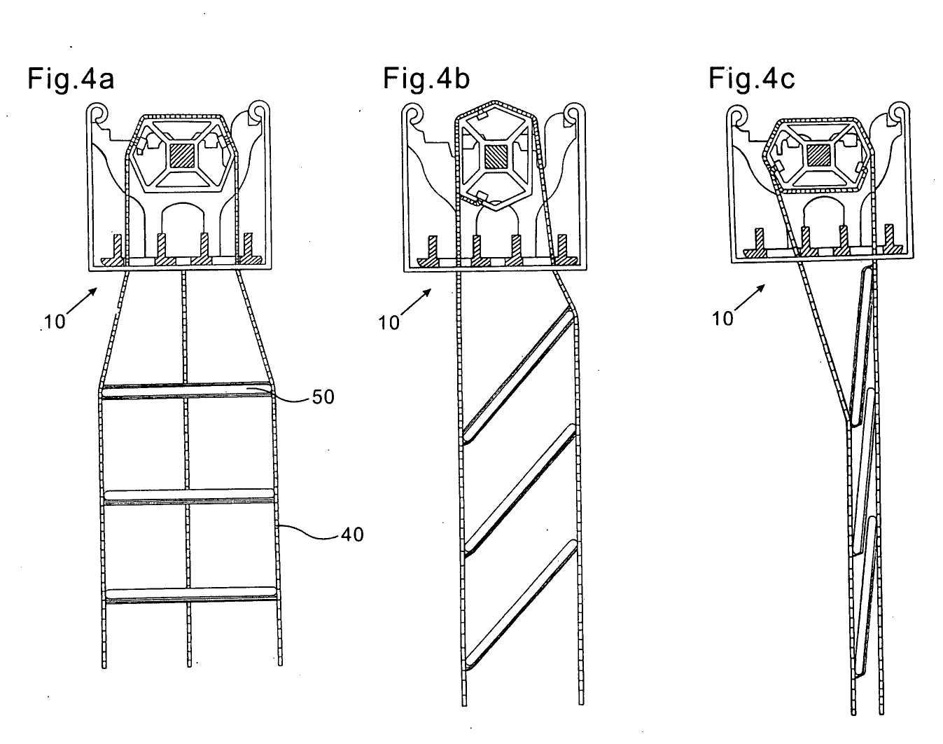

Turning now to FIGS. 4a-4c, the polygonal tilt drum 10 is illustrated in progressive stages of operation, wherein the ladder cord 40 is retained within notches N1 and N2, and the slats 50 are shown at different degrees of closure with the counterclockwise rotation of the tilt drum. It should be noted that this particular adjustment to the slats is made by way of example only, and the tilt drum may be rotated in a clockwise direction. Within FIG. 4a, the polygonal tilt drum 10 is positioned at a 0° angle, and the slats 50 are positioned in parallel relation. As shown in FIG. 4b the tilt drum 10 is rotated at a 90° angle, and the slats 50 are approximately tilted at a 60° angle. In FIG. 4c the tilt drum 10 is rotated at a 180° angle and the slats 50 are shown in a closed relation. The tight closure of the slats is achieved because the hexagonal facets of the tilt drum 10 enhance the full range of vertical motion for the corresponding legs 5 and 6 of the ladder cord 40.

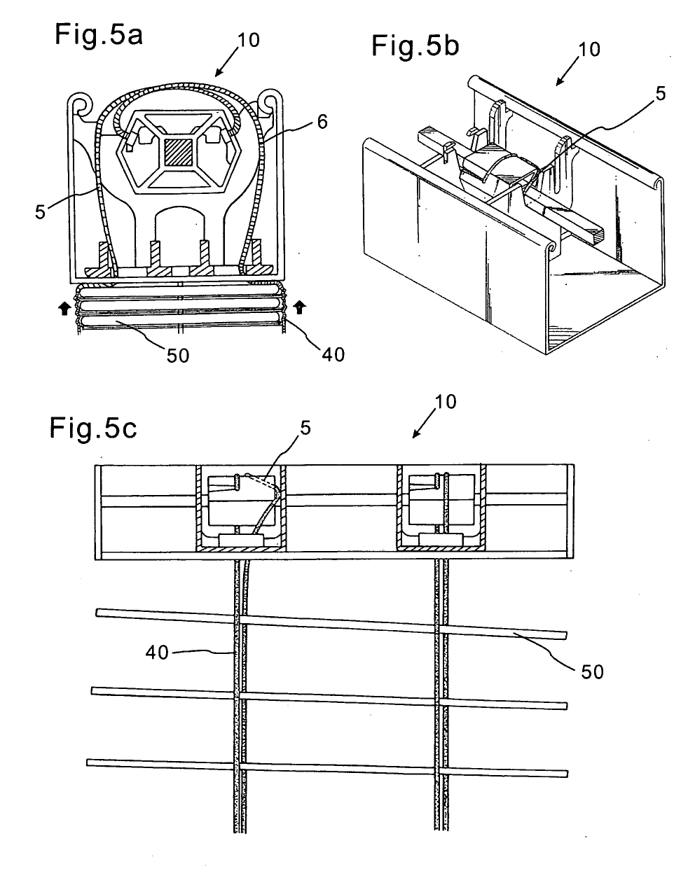

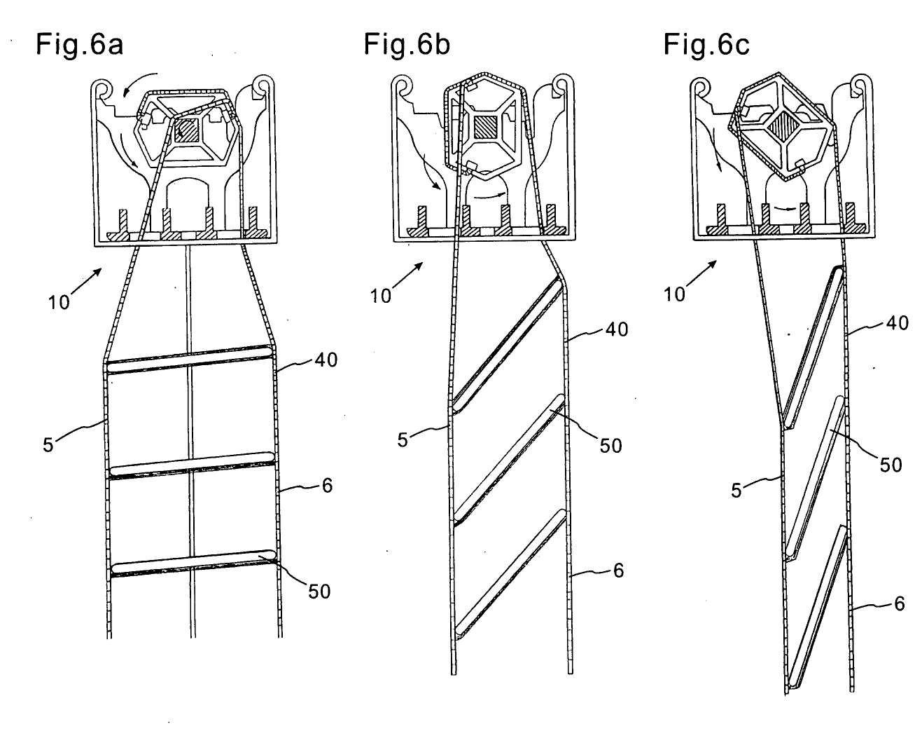

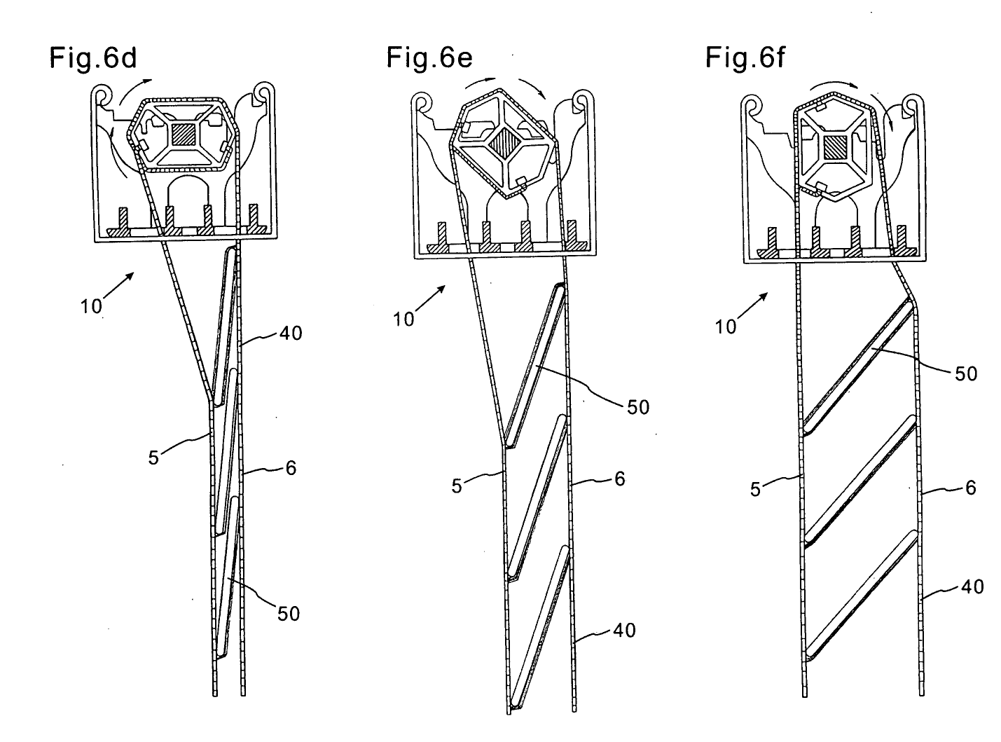

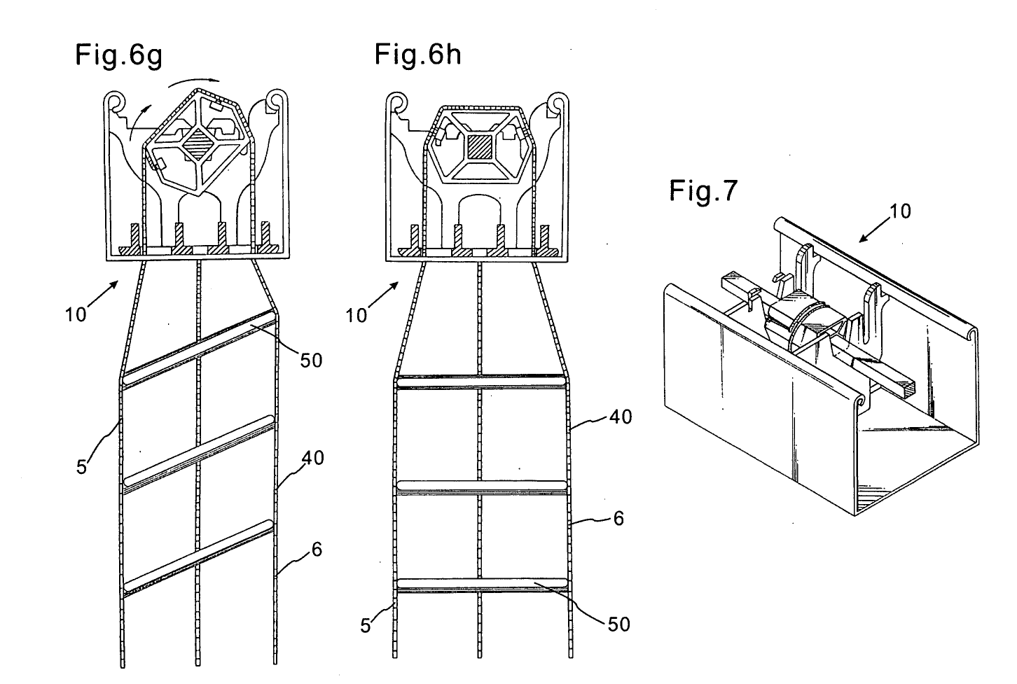

As illustrated in FIGS. 5a-5c, when the slats 50 of a venetian blind are completely raised and locked into place, the tension retaining the position of the ladder cord 40 dissipates, causing the formation of slack in the ladder legs 5 and 6. In this condition, and due to the lightweight and flexible properties inherent within braided cords, the attached legs of the ladder cord may un-spool from the tilt drum 10 and become entangled with other components of the tilt mechanism. Without adjustment, the tangled cords will result in the unleveled suspension of the slats as seen in FIG. 5c. In accordance with the present invention, FIGS. 6a-6h, illustrate the self-aligning properties of tilt drum 10 in progressive stages of operation, wherein ladder leg 5 has become entangled within the tilt mechanism. With the bi-directional rotation of tilt rod R, the notch N2 of the polygonal tilt drum engages the misaligned ladder leg 5, and respools the ladder cord onto the tilt mechanism—this process is by way of example only, where ladder leg 6 would also become similarly engaged by notch N1 if it were to un-spool from tilt drum 10. FIG. 7 illustrates the proper alignment of the ladder cord after the re-spooling process.

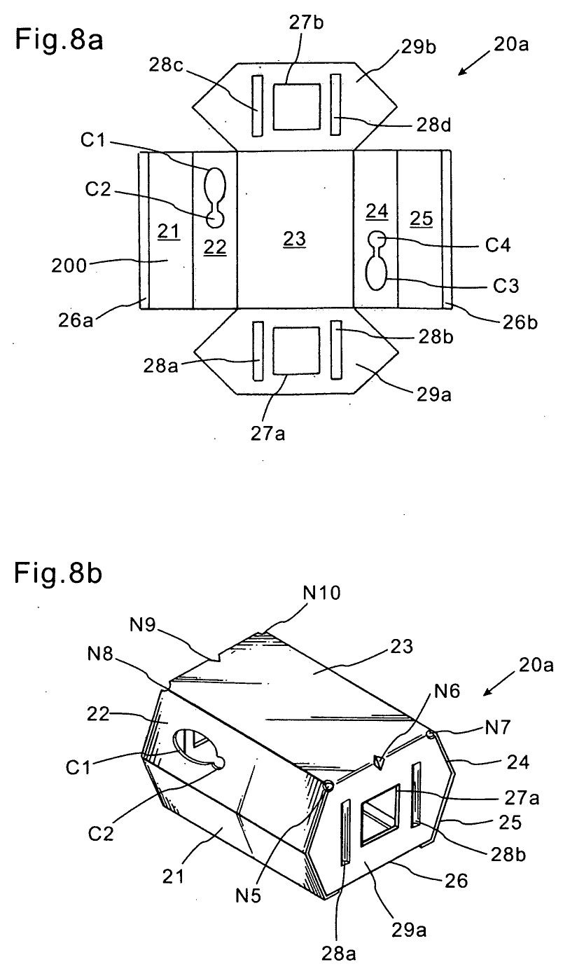

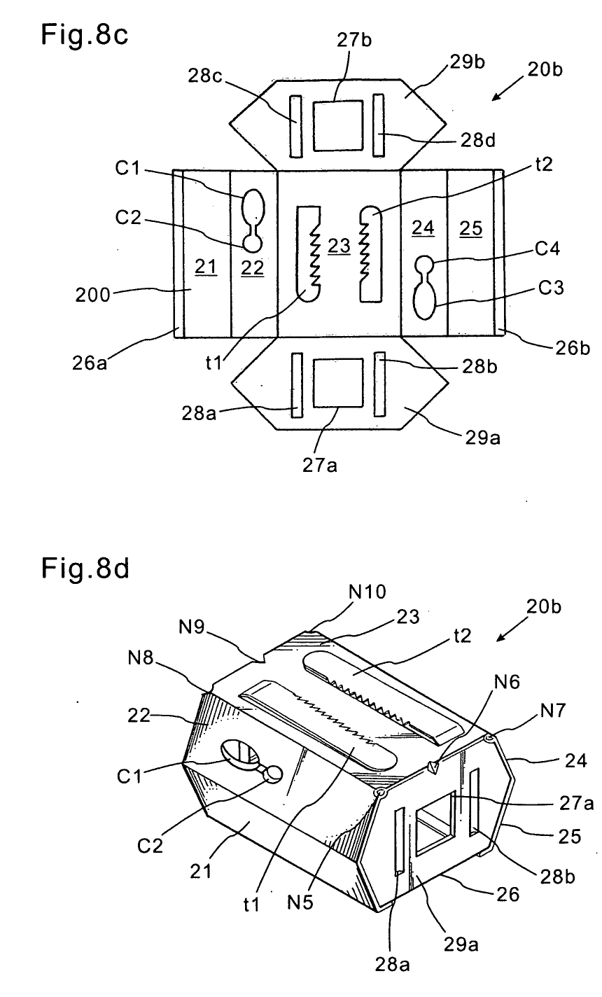

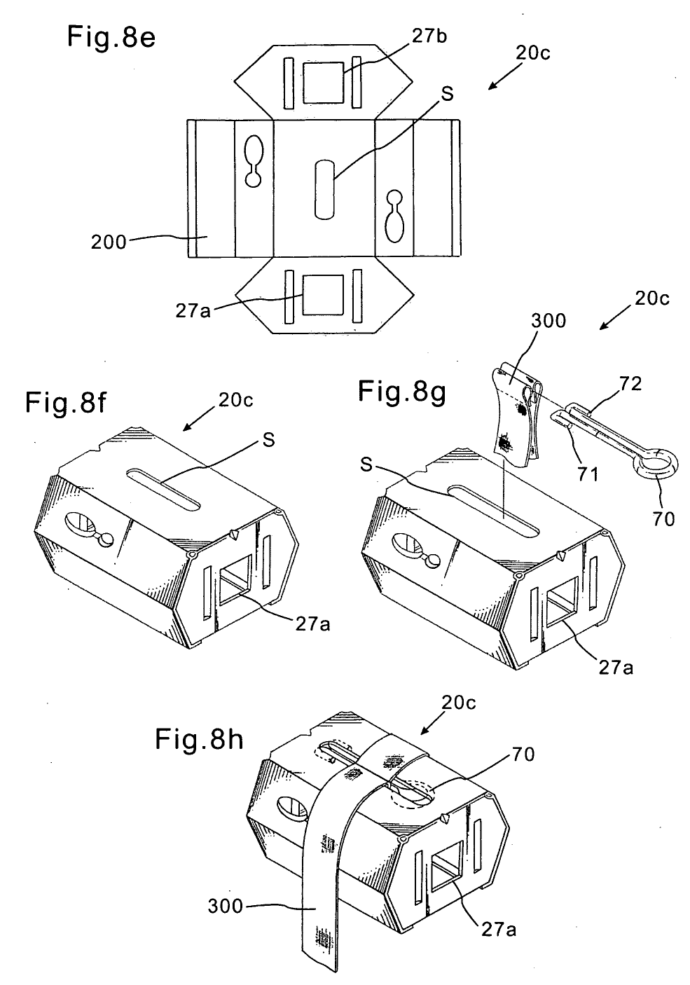

Within an alternate embodiment of the invention, and as seen in FIGS. 8a-8h, polygonal tilt drums 20a, 20b, or 20c may also be fabricated from a die stamping, wherein a metal blank 200 is cut and creased into a series of seven rectangular facets 21, 22, 23, 24, 25, 26a and 26b, with two connected laterally extending hexagonal side sections 29a and 29b, all of which fold inward to form the preferred hollow hexagonal profile. It is further contemplated that other multi-faceted profiles may be used, such as pentagons, heptagons, octagons, nonagons, decagons, hendecagons or dodecagons without departing from the spirit or scope of the instant invention. Within the preferred hexagonal embodiment, each adjoining rectangular facet or sidewall is oriented at 120° to one another, where the hexagonal sides are bent at right angles. The top wall 23 and bottom wall 26 of the profile body are equal in measurement, and the bottom surface 26 of the tilt drum defines an opening (not shown) into the hollow tilt drum cavity, which is framed by two small rectangular facets 26a and 26b and two opposing edge segments of the folded hexagonal sections 29a and 29b. The four remaining mediate sidewalls 21, 22, 24, and 25 are of equal dimension but somewhat shorter than the top and bottom surfaces. The sidewalls 21, 22, 23, 24, 25, 26a and 26b of the tilt drums 20a and 20b are enfolded around the peripheral edges of the hexagonal side sections 29a and 29b. A series of relief notches N5, N7, N8 and N9, along with V-shaped crimped notches N6 and N9, also serve to catch and re-spool misaligned ladder cords upon the rotation of the venetian blind tilt mechanism—when such ladders are selected for assembly. The hexagonal side sections additionally have die cut apertures 27a and 27b to accommodate the insertion of a tilt rod, and each section 29a and 29b has two die stamped grooves 28a and 28b, along with 28c and 28d, to provide structural strength to the component. To facilitate the attachment of braided ladder cord, the two upper mediate sidewalls 22 and 24 of the polygonal tilt drum are each die cut with two intersecting ovular holes C1 and C2, along with C3 and C4, the first opening greater in proportion than the second, to accommodate the attachment of the cord support legs. An enlarged tab is firmly attached to each end of each leg of the ladder cord (not shown), and to effectively counter balance the weight of the suspended slats, the tabbed end segments of the ladder legs cross over the body of the tilt drum, and each tab is then correspondingly inserted into the larger openings C1 and C3, which are subsequently moved and secured into position behind each smaller ovular openings C2 and C4. As illustrated in FIGS. 8c and 8d, the polygonal tilt drum 20b may optionally have die stamped serrated prongs t1 and t2 to retain the loops of woven ladder tape (not shown), with the inward facing edge of each member having saw-toothed projections to grip and secure each ladder leg into position. Alternatively, and as seen in FIGS. 8e-8h, the tilt drum 20c may also accommodate the use of ladder tapes 300 through the use of a cotter key attachment 70—having a set of retaining prongs 71 and 72—to fasten the loops formed at the top ends of each corresponding ladder leg; the assembly of which is then inserted into an access slot S that is die cut into the top wall of the profile body.

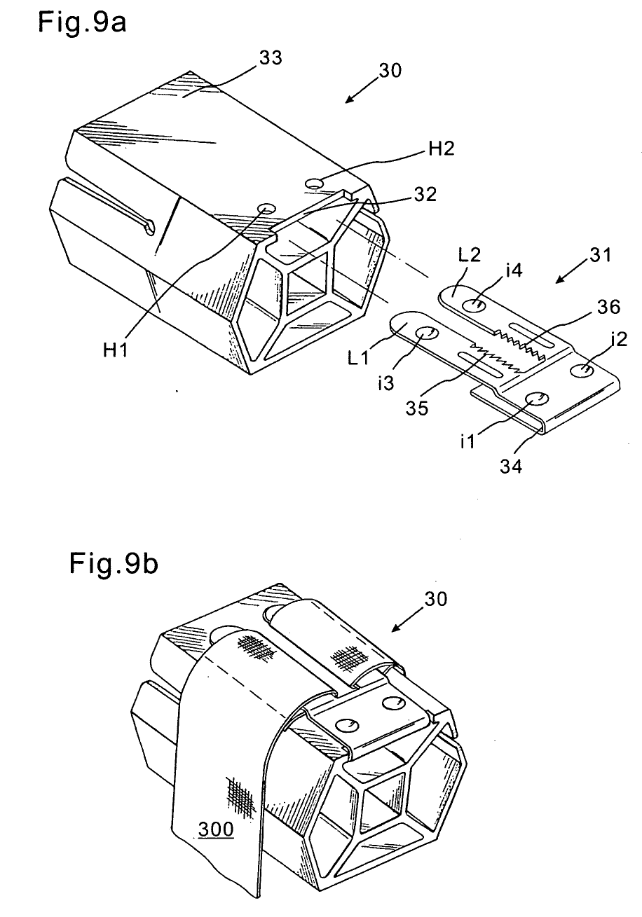

Finally, FIGS. 9a and 9b illustrate yet another embodiment of the invention, wherein the polygonal tilt drum 30 may be adapted to accommodate the insertion of a serrated U-shaped clip 31 to retain woven ladder tapes 300. So that the ladder clip may be fitted into position, the top sidewall 33 of the injection molded tilt drum is formed with a recess 32 along the peripheral edge of the component, in combination with to holes H1 and H2 located on the top plane 33 of the profile which are adjacent to the indented recess. The U-shaped clip is preferably a metal die stamping, which is generally of the same width as the molded recess 32, and is folded over 34 to clasp the top sidewall of the tilt drum. The clip may be formed with a pattern of circular indentations I1, 12, 13 and 14, wherein at least two impressions I1 and 12 correspondingly friction fit with the holes H1 and H2 located within the top sidewall or, alternatively, may have die cut holes to receive fasteners. To retain the loops of the woven ladder tape 300 into position, the inward facing edge 35 and 36 of each projection L1 and L2 has serrations, with each tooth having a ramp facing the open-end portion of the clip 31, and each having a right-angle stop surface facing the U-shaped terminus of the part. The looped ends of each ladder leg are slid over each corresponding projection L1 and L2 of the U-shaped clip, which is then inserted into the tilt drum recess.

Even though numerous characteristics and advantages of the present invention have been set forth in the foregoing description, together with details of the structure and function of the preferred embodiments, the above disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A ladder drum, which pivotally mounts to a control rod within a Venetian blind tilt mechanism, for selectively regulating the angular adjustment and closure of slats in a horizontal blind assembly of the type incorporating ladder cords, said ladder drum comprising:
an elongated polygonal cylindrical structure having a plurality of exterior plane sidewalls defining a substantially hollow interior, said exterior sidewalls having at least two walls that are equal in dimension but that are greater in measurement than the remaining mediate sidewalls that define the profile structure;
a tilt rod aperture longitudinally extending through the central section of the polygonal cylindrical structure, said aperture formed to correspondingly receive a polygonal control rod of the Venetian blind tilt mechanism;
a hollow profile segmented by at least two primary reinforcing ribs which are oriented at vertical angles and diverge from the central tilt rod aperture, thereby defining a sequence of at least four cavities within the profile structure; and
a pair of tapered access slots, laterally converging in parallel relation to each other from the front and rear edges of two nonadjacent mediate sidewalls, each terminating with an enlarged intersecting aperture to accommodate the insertion and retention of corresponding tabbed ladder legs of a ladder cord.

2. The ladder drum of claim 1, wherein the number of plane sidewalls defining the polygonal structure are greater than four sidewalls, and less than or equal to twelve sidewalls.

3. The ladder drum of claim 2, wherein the internal angular orientation of each adjacent plane sidewall is in the range of 90° to 150°.

4. The ladder drum of claim 2, wherein the number of plane sidewalls is preferably six sidewalls, forming an uneven hexagonal profile.

5. The ladder drum of claim 1, wherein the cavities defined by reinforcing ribs extend longitudinally through the polygonal cylindrical structure.

6. The ladder drum of claim 1, wherein each tapered access slot has a flared notched opening to catch and re-spool misaligned ladder legs upon the bi-directional rotation of the Venetian blind control rod.

7. The ladder drum of claim 1, wherein the tabbed end segments of the ladder legs cross over the body of the polygonal cylindrical structure, and each are inserted and retained within an opposing tapered access slot.

8. The ladder drum of claim 1, wherein the ladder drum is molded as one piece.

9. The ladder drum of claim 8, wherein the ladder drum is plastic.

10. A ladder drum, which pivotally mounts to a control rod within a Venetian blind tilt mechanism, for selectively regulating the angular adjustment and closure of slats in a horizontal blind assembly of the type incorporating ladder cords or tape ladders, said ladder drum comprising:
an elongated polygonal cylindrical structure formed from a metal blank that is cut and creased into a series of rectangular facets, with two laterally extending side sections having a perimeter geometry corresponding to the configuration of the tilt drum profile, the facets and sections of which fold inward to form an enclosed hollow structure;
a pair of aligned tilt rod apertures that are centrally located within the laterally extending side sections, said apertures being contoured to receive the insertion of a polygonal control rod of the Venetian blind tilt mechanism; and
a pair of access slots reciprocally located on nonadjacent mediate sidewalls of the profile body to accommodate the insertion and retention of corresponding tabbed ladder legs of a ladder cord.

11. The ladder drum of claim 10, wherein the metal blank has a rectangular portion defined by four edges intersecting at four right angles, and bordered by a pair of parallel creases which are each adjacent to the laterally extending side sections.

12. The ladder drum of claim 11, wherein the rectangular portion is creased into a series of rectangular facets which are in parallel relation to each other, and which form the plane sidewalls of the polygonal profile.

13. The ladder drum of claim 11, wherein the rectangular portion has a centrally located rectangular facet that is greater in proportion than the remaining facets composing the profile structure.

14. The ladder drum of claim 11, wherein the rectangular portion has two rectangular facets of equal dimension, but which are the smallest in measurement of any facet composing the profile structure, and are each laterally located at opposite edges of the rectangular area.

15. The ladder drum of claim 12, wherein the series of rectangular facets, forming the plane sidewalls of the polygonal profile, define a polygonal structure greater than four sidewalls, and less than or equal to twelve sidewalls.

16. The ladder drum of claim 12, wherein the internal angular orientation of each adjacent plane sidewall is in the range of 90° to 150°.

17. The ladder drum of claim 12, wherein the number of plane sidewalls is preferably six sidewalls, forming an uneven hexagonal profile.

18. The ladder drum of claim 10, wherein the laterally extending side sections each have a pair of formed grooves to provide structural strength to the polygonal structure.

19. The ladder drum of claim 10, wherein the laterally extending side sections are folded along adjacent creases bordering the rectangular portion at 90° angles, and the creased rectangular facets are enfolded around the peripheral edges of the side sections thereby forming the plane sidewalls of the polygonal structure.

20. The ladder drum of claim 19, wherein the two smallest sidewalls, and two opposing edge segments of the lateral sidewalls, create an open frame that is equal in measurement to the largest plane sidewall of the ladder drum profile.

21. The ladder drum of claim 19, wherein a series of relief notches and V-shaped crimped notches join the plane sidewalls and laterally extending side sections, and also serve to catch and re-spool misaligned ladder cords upon the bi-directional rotation of the Venetian blind control rod.

22. The ladder drum of claim 10, wherein the pair of reciprocally located access slots consist of a series of two intersecting ovular holes, the first opening greater in proportion than the second, to accommodate the insertion and retention of corresponding tabbed ladder legs of a ladder cord.

23. The ladder drum of claim 10, wherein the tabbed end segments of the ladder legs cross over the body of the polygonal cylindrical structure, and each are inserted and retained within an opposing access slot.

24. The ladder drum of claim 13, wherein the centrally located rectangular facet may be die stamped with a set of serrated prongs to retain the loops of ladder tape, with the inward facing edge of each member having saw-toothed projections to grip and secure each ladder leg into position.

25. The ladder drum of claim 13, wherein the centrally located rectangular facet may be die stamped with an access slot extending lengthwise through the profile body.

26. The ladder drum of claim 25, wherein a fastener is used to retain the looped end segments of ladder tape.

27. The ladder drum of claim 26, wherein the assembled fastener and looped ladder legs are inserted through the central access slot, thereby securing the ladder tape to the ladder drum.

28. A ladder drum, which pivotally mounts to a control rod within a Venetian blind tilt mechanism, for selectively regulating the angular adjustment and closure of slats in a horizontal blind assembly of the type incorporating ladder cord or tape ladders, said ladder drum comprising:
an elongated polygonal cylindrical structure having a plurality of exterior plane sidewalls defining a substantially hollow interior, said exterior sidewalls having at least two walls that are equal in dimension but that are greater in measurement than the remaining mediate sidewalls that define the profile structure;
a tilt rod aperture longitudinally extending through the central section of the polygonal cylindrical structure, said aperture formed to correspondingly receive a polygonal control rod of the Venetian blind tilt mechanism;
a hollow profile segmented by at least two primary reinforcing ribs which are oriented at vertical angles and diverge from the central tilt rod aperture, thereby defining a sequence of at least four cavities within the profile structure; and
a pair of tapered access slots, laterally converging in parallel relation to each other from the front and rear edges of two nonadjacent mediate sidewalls, each terminating with an enlarged intersecting aperture to accommodate the insertion and retention of corresponding tabbed ladder legs of a ladder cord.

29. The ladder drum of claim 28, wherein the peripheral edge of at least one of the greater proportioned exterior plane sidewalls has an indented recess to accommodate the insertion of a detachable U-shaped clip to retain the looped ends of ladder tapes.

30. The ladder drum of claim 28, wherein a series of two holes are located within the same plane sidewall as the formed recess, said holes being positioned adjacent to the indented recess.

31. The ladder drum of claim 29, wherein the U-shaped clip is generally the same width as the indented recess, and is folded over to clasp the plane sidewall of the ladder drum.

32. The ladder drum of claim 29, wherein the U-shaped clip has a pattern of circular indentations, with at least two impressions positioned to friction fit with the holes located within the plane sidewall.

33. The ladder drum of claim 29, wherein the U-shaped clip has inward projecting serrations, with each tooth having a ramp facing the open-end portion of the clip, and each having a right-angle stop surface facing the U-shaped terminus of the part.

34. The ladder drum of claim 29, wherein the U-shaped clip is a metal die stamping.

35. The ladder drum of claim 28, wherein the number of plane sidewalls defining the polygonal structure are greater than four sidewalls, and less than or equal to twelve sidewalls.

36. The ladder drum of claim 35, wherein the internal angular orientation of each adjacent plane sidewall is in the range of 90° to 150°.

37. The ladder drum of claim 35, wherein the number of plane sidewalls is preferably six sidewalls, forming an uneven hexagonal profile.

38. The ladder drum of claim 28, wherein the cavities defined by reinforcing ribs extend longitudinally through the polygonal cylindrical structure.

39. The ladder drum of claim 28, wherein each tapered access slot has a flared notched opening to catch and re-spool misaligned ladder cord legs upon the bi-directional rotation of the Venetian blind control rod.

40. The ladder drum of claim 28, wherein the tabbed end segments of the ladder cord legs cross over the body of the polygonal cylindrical structure, and each are inserted and retained within an opposing tapered access slot.

41. The ladder drum of claim 28, wherein the ladder drum is molded as one piece.

42. The ladder drum of claim 41, wherein the ladder drum is plastic.
